(19) United States
(12) Patent Application Publication
(10) Pub. No.: US 2003/0108663 A1
(43) Pub. Date: Jun. 12, 2003

(54) Method of manufacturing a luminescent screen for a CRT

(76) Inventors: George Milton Ehemann JR., Lancaster, PA (US); Brian Thomas Collins, Lititz, PA (US)

Correspondence Address: Joseph S. Tripoli, THOMSON multimedia Licensing Inc., Patent Operations, Two Independence Way, Post Office Box 5312, Princeton, NJ, 08540-5312, US

(21) Appl. No.: 10/008,701

(22) Filed: Dec. 7, 2001

(51) Int. Cl. B05D 5/12

(52) U.S. Cl. 427/66; 427/68

(57) ABSTRACT

A method of manufacturing a luminescent screen assembly for a color cathode-ray tube (CRT) is disclosed. The luminescent screen assembly is formed on an inner surface of a face plate panel of the CRT. The luminescent screen assembly includes an organic conductive (OC) layer overcoated with an organic photoconductive (OPC) layer. Three different color-emitting phosphors are sequentially deposited over portions of the OPC layer by uniformly charging to having a surface charge of one polarity and than selectively discharging desired areas thereof of the OPC layer. Appropriate color-emitting phosphors having the opposite polarity charge as that of the OPC layer are then deposited on the charged areas.

### FIELD OF THE INVENTION

The invention relates to a color cathode-ray tube (CRT) and, more particularly to a color CRT including a luminescent screen.

### BACKGROUND

A color cathode-ray tube (CRT) typically includes an electron gun, an aperture mask, and a screen. The aperture mask is interposed between the electron gun and the screen. The screen is located on an inner surface of a face plate of the CRT tube. The aperture mask functions to direct electron beams generated in the electron gun toward appropriate color-emitting phosphors on the screen of the CRT tube.

The screen may be a luminescent screen. Luminescent screens typically comprise an array of three different color-emitting phosphors (e.g., green, blue, and red). Each color-emitting phosphor is separated one from the other by a matrix line. The matrix lines are formed of a light-absorbing black inert material.

Luminescent screens may be formed using an electrophotographic screening (EPS) process. In EPS Processes, an organic photoconductive (OPC) layer is sprayed over an organic conductive (OC) layer, formed on an interior surface of a face plate panel having matrix lines formed thereon. The three different color-emitting phosphors are then sequentially deposited on portions of the OPC layer. Each of the three different color-emitting phosphors is sequentially deposited by first uniformly charging the OPC layer and then selectively discharging portions thereof with light from a lighthouse, which passes through the aperture mask at angles corresponding to the angles at which the electron beams would pass during operation in a finished CRT. Appropriately charged color-phosphors are then deposited on the discharged portions of the OPC layer. This development method is referred to as reversal development.

However, after the first color-emitting phosphor lines are deposited on the OPC layer, the phosphor-deposited portions of the OPC layer have a higher electrostatic potential than the bare OPC portions. When the OPC is selectively charged and discharged to deposit the second color-emitting phosphor lines, this higher electrostatic potential causes the deposition of the second color phosphor lines to be misaligned with respect to the deposition of the first color-emitting phosphor lines as described in U.S. Pat. No. 5,455,132.

The reversal development system has also proven to be problematic for larger aperture mask systems, which are characterized as masks having apertures exceeding 35% of the mask pitch. In these wider aperture mask systems, it has been found that even under the best known light exposure conditions during the discharging step the widths of the discharged regions of the OPC are larger than the desired widths of the phosphor lines. As such, during the phosphor development step the phosphor has a tendency to spread beyond the desired width and in many case does not deposit to the desired height.

Accordingly, a new method for forming the color phosphors on a luminescent screen is required.

### SUMMARY OF THE INVENTION

The present invention relates to a method of manufacturing a luminescent screen for a color cathode-ray tube (CRT). The luminescent screen is formed on an inner surface of a face plate panel of the CRT. The method of manufacturing the luminescent screen includes applying an organic conductive (OC) layer, applying an organic photoconductive (OPC) layer and then sequentially depositing over portions of the OPC layer three different color-emitting phosphors. Each of the sequential depositing steps includes uniformly charging the OPC layer to a have a surface charge, selectively discharging desired areas thereof OPC layer, and depositing the appropriate color-emitting phosphors having a charge of the opposite polarity as that of the OPC layer, onto areas of the OPC layer not selectively discharged.

### BRIEF DESCRIPTION OF THE DRAWINGS

The invention will now be described in greater detail, with relation to the accompanying drawings.

FIG. 1 is a plan view, partly in axial section, of a color cathode-ray tube (CRT) made according to the present invention.

FIG. 2 is a section of a face plate panel portion of the CRT of FIG. 1, showing a luminescent screen.

FIG. 3 is a block diagram comprising a flow chart of the manufacturing process for the screen of FIG. 2.

FIGS. 4a-4e depict views of the interior surface of the face plate screen during photoreceptor formation.

### DETAILED DESCRIPTION OF THE INVENTION

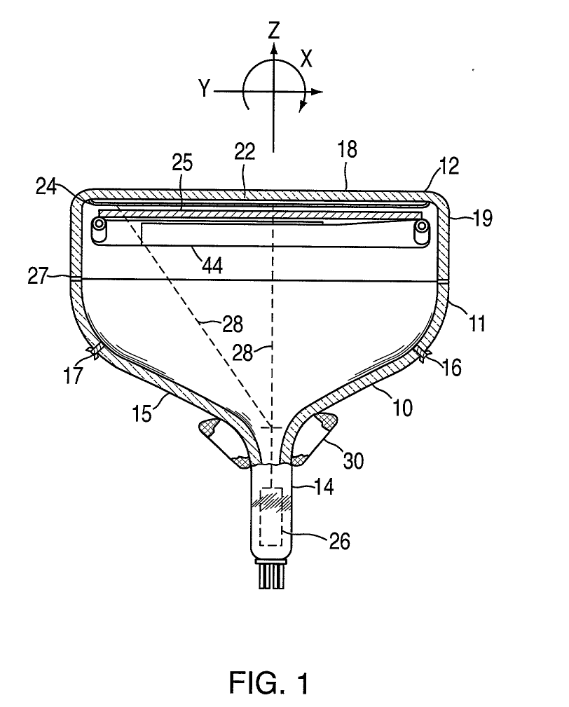

FIG. 1 shows a color cathode-ray tube (CRT) 10 having a glass envelope 11 comprising a face plate panel 12 and a tubular neck 14 connected by a funnel 15. The funnel 15 has an internal conductive coating (not shown) that is in contact with an anode button 16 and extends toward the panel 12 and toward to the neck 14.

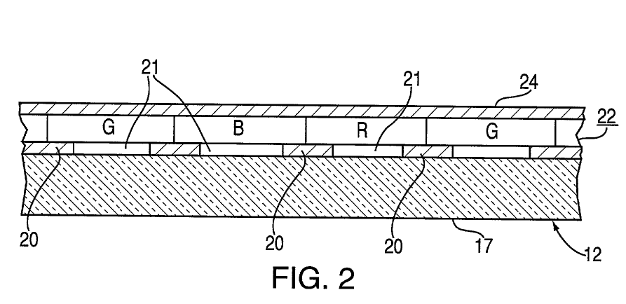

The face plate panel 12 comprises a viewing face plate 18 and a peripheral flange or sidewall 19 that is sealed to the funnel 15 by a glass frit 27. A three-color luminescent phosphor screen 22 is carried on the inner surface of the face plate 18. The screen 22, shown in cross-section in FIG. 2, is a line screen which includes a multiplicity of screen elements comprising red-emitting, green-emitting, and blue-emitting phosphor stripes R, G, and B, respectively, arranged in triads, each triad including a phosphor line of each of the three colors. The R, G, B, phosphor stripes extend in a direction that is generally normal to the plane on three in-line electron beams 28, which respectively correspond to the three phosphors and are generated from the electron gun 26 which is centrally mounted in the neck 14. The beams 28 have a center and two side outer beams, which follow along a convergent paths through the mask 25 to the screen 22.

A light absorbing matrix 20, shown in FIG. 2, separates the phosphor lines. A thin conductive layer 24, preferably of aluminum, overlies the screen 22 and provides means for applying a uniform first anode potential to the screen 22, as well as for reflecting light, emitted from the phosphor elements, through the face plate 18. The screen 22 and the overlying aluminum layer 24 comprise a screen assembly.

A multi-aperture color selection electrode, or mask 25, is removably mounted, by conventional means, within the face plate panel 12, in predetermined spaced relation to the screen 22.

The CRT of FIG. 1 is designed to be used with an external magnetic deflection yoke, such as the yoke 30, shown in the neighborhood of the funnel-to-neck junction. When activated, the yoke 30 subjects the three electron beams 28 to magnetic fields that cause the beams to scan a horizontal and vertical rectangular raster across the screen 22.

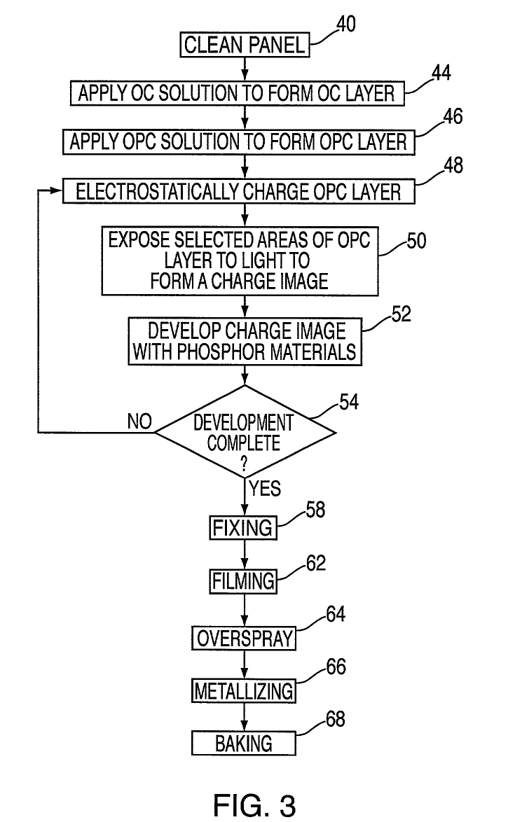

The screen 22 is manufactured using an electrophotographic screening (EPS) Process that is shown schematically in FIG. 3. Initially, the panel 12 is cleaned, as indicated by reference numeral 40, by washing it with a caustic solution, rinsing it in water, etching it with buffered hydrofluoric acid (HF) and rinsing it again with water, as is known in the art.

The interior surface of the viewing face plate 18 is then provided with the light absorbing matrix 20. For a face plate panel 12 having a diagonal dimension of about 68 cm (27 inches), the openings 21 formed in the layer of light-absorbing matrix 20 have widths in a range of about 0.075 mm to about 0.25 mm, and the opaque matrix lines have widths in a range of about 0.075 mm to about 0.25 mm.

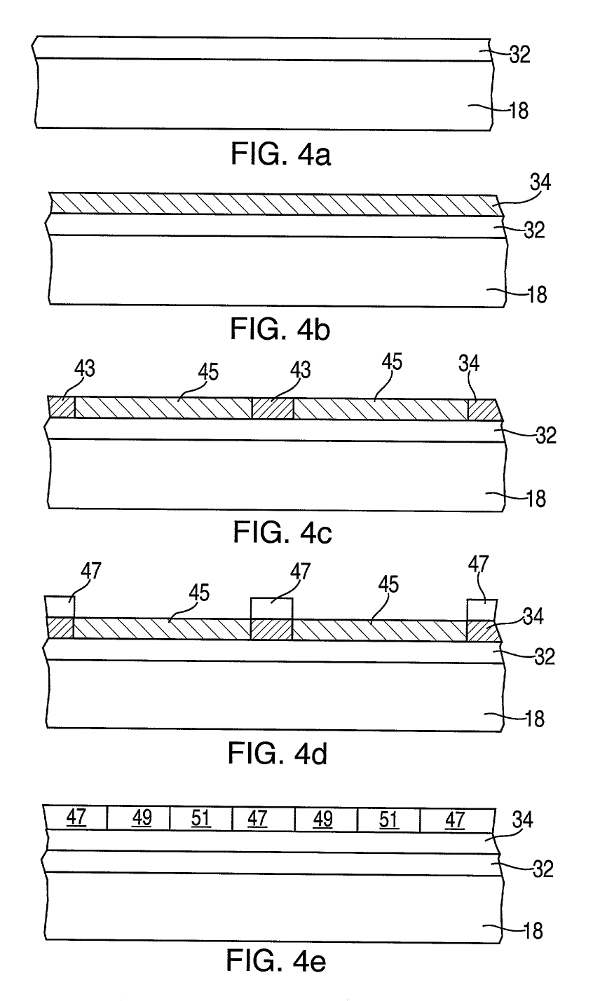

Referring to FIG. 4a, the interior surface of the viewing face plate 18 is then coated with a suitable layer of a volatilizable, organic conductive (OC) layer 32. Suitable materials for the OC layer 32 include quaternary ammonium polyelectrolytes such as, for example, poly(dimethyl-diallyl-ammonium chloride), poly(3,4-dimethylene-N-dimethyl-pyrrolidium chloride)(3,4-DNDP chloride), poly(3,4-dimethylene-N-dimethyl-pyrrolidium nitrate), and poly(3,4-dimethylene-N-dimethyl-pyrrolidium phosphate)(3,4-DNDP phosphate). Alternatively, vinylimidazolium methosulfate (VIM), and vinylpyrrolidone (VP) may be used. A polythiophene may also be used such as 3,4-polyethylene dioxythiophene. The OC layer 32 typically has a thickness within a range of about 0.5 microns to about 3 microns.

An organic photoconductive (OPC) layer 34 is formed over the OC layer 32, as shown in FIG. 4b and indicated in step 46. The OPC layer 34 is formed by overcoating the OC layer 32 with an OPC solution containing a polystyrene resin, an electron donor material, such as 1,4-di(2,4-methyl phenyl)-1,4-diphenylbutatriene (2,4-DMPBT), electron acceptor materials, such as 2,4,7-trinitro-9-fluorenone (TNF) and 2-ethylanthroquinone (2-EAQ), and a suitable solvent, such as toluene, xylene, or a mixture of toluene and xylene. A surfactant, such as silicone U-7602), and a plasticizer, such as dioctyl phthalate (DOP), may also be added to the OPC solution. The surfactant U-7602 is commercially available from Union Carbide, Danbury, Conn.

The composition of the OPC solution preferably comprises about 4.8% by weight to about 7.2% by weight of the polystyrene resin, about 0.8% by weight to about 1.3% by weight of the electron donor material (2,4-DMBPT), about 0.04% by weight to about 0.06% by weight of TNF and about 0.12% by weight to about 0.36% by weight of 2-EAQ, as electron acceptor materials, about 0.3% by weight of a plasticizer (DOP), about 0.01% by weight of a surfactant (silicone U-7602), and the balance comprising a mixture of toluene and xylene. The toluene concentration in the OPC solution is preferably within a range of about 18% by weight to about 75% by weight and the xylene concentration is preferably within a range of about 18% by weight to about 75% by weight. The total solid content of the OPC solution should be within a range of about 6% by weight to about 9% by weight, and preferably within a range of about 7% by weight to about 8% by weight.

The OPC solution may be applied over the OC layer 32 using electrostatic spray guns (not shown). Suitable electrostatic spray guns include AEROBELL™ electrostatic spray guns commercially available from ITW Ransburg, Toledo, Ohio.

The electrostatic spray guns provide an aerosol of negatively charged droplets of the OPC solution on the OC layer 32. The OC layer 32 is grounded during the electrostatic spraying operation, in order to attract the negatively charged droplets of the OPC solution toward the more electrically positive OC layer 32.

After the OPC layer 34 is applied, it is uniformly electrostatically charged, as indicated by reference numeral 48, using a corona discharge device (not shown). The OPC layer 34 is charged to a voltage within a range of about −200 volts to about −600 volts, and preferably within the range of about −400 volts to about −600 volts.

Thereafter, the mask is inserted into the face plate panel 12, placed in a lighthouse (not shown), and exposed, through the mask, to light from a suitable light source disposed within the lighthouse. The light passes through the apertures in the mask 25, at predetermined angles thereby selectively and substantially discharging negatively charged areas 45. This results in first phosphor areas 43 on the OPC layer 34 which maintain substantial charge and are referred to as charge images, as indicated by reference numeral 50 in FIG. 3 and shown in FIG. 4c. This first phosphor area represents the general location where the electron beam 28 for the first color phosphor will land.

The mask 25 is removed from the face plate panel 12, and the panel is placed onto a first phosphor developer containing, first color-emitting phosphor material, to develop the charge image, as indicated by reference numeral 52.

The first color-emitting phosphor material is positively triboelectrical charged within the developer and directed toward the OPC layer 34. The first color-emitting phosphor material is positively charged within a range of about 2 μC/gram to about 10 μC/gram. The positively charged first color-emitting phosphor material 47 is attracted to and binds onto the negatively charged first phosphor areas 43 on the OPC layer 34, as shown in FIG. 4d. Since three different color-emitting phosphors are required to form the screen 22, the charging step 48, the light exposure step 50 and the phosphor development step 52 are repeated for each of the second and third color-emitting phosphors 49, 51, as shown in FIG. 4e. The development process is referred to as attraction development.

Alternatively, the three different color-emitting phosphors may be formed directly on the interior surface of the viewing face plate 18. For such an embodiment, the light absorbing matrix 20 is not formed on the face plate panel 12.

Such an EPS screening process advantageously forms phosphor elements with substantially flat surfaces, without piling of the phosphor material on phosphor lines. (Piling is a phenomenon seen in reversal development EPS systems wherein phosphor particles excessively land in the central portions of the predetermine deposition area, thereby causing a reduction in light output during tube operation where the piled phosphor exists in systems with conventional mask aperture widths, i.e., about 20% of the mask pitch.) U.S. Pat. No. 5,455,132 describes a reversal development system. The current invention surprisingly prints phosphor lines with finer edge definition. Additionally, there is less cross contamination between adjacent color phosphors.

After the three color-emitting phosphors are deposited on the OPC layer 34, fixing and filming processes are performed, as indicated by steps 58 and 62 in FIG. 3, to provide a smooth surface over the screen 22 onto which an evaporated aluminum layer 24 can be deposited. Typically, after filming, an overspray of boric acid or ammonium oxalate, as is known in the art, is applied. Suitable fixative compositions comprise mixtures of solvents such as methyl isobutyl ketone (MIBK) and d-limonene. Suitable filming compositions may comprise acrylic polymers such as butyl methacrylate and polymethylmethacrylate.

After fixing and filming the three color-emitting phosphors on the OPC layer 34, the screen 22 is aluminized and then baked at a temperature of about 425 OC for about 30 minutes, to volatilize constituents remaining on such screen 22 (e.g., the OC layer, the OPC layer, and the filming layer).

It should also be pointed out that this invention has particular efficacy to CRTs having masks 25 with wider apertures relative to the apertures of similar sized CRTs with equivalent mask pitch. This includes systems where the aperture width approaches 50% of the mask pitch. Theoretically, the invention should work in a system where the mask aperture is about 70%. In these wider aperture mask systems, it has been found that through the appropriate exposure of light during the discharging or exposure step, reference numeral 50, the width of the negatively charged first phosphor areas 43 on the OPC layer 34 can effectively be the same as the target width for the phosphor stripe, whereby it is easier to build up the depth of the phosphor during the developing step 52 without the phosphor line uncontrollably spreading into the adjacent phosphor areas. This capability of being able to make the width of area 43 nearly equal to the targeted line width has not been achieved in a reversal development system for these wider aperture mask systems.

Another feature of the invention is that the second color phosphor particles do not experience any appreciable electrostatic forces from the first color phosphor particle, which would otherwise cause an asymmetric deposit of the second color in a reversal system unless the technique taught in U.S. Pat. No. 5,455,132 is employed.

Those skilled in art can appreciate that other and further embodiments of the invention exist without departing from the basic scope thereof, and the scope thereof is determined by the claims that follow. Some of the other embodiments include using the reversal development process for at least one of the color phosphor development and using the inventive attraction development for the others. While other embodiments incorporate the use of negatively charged phosphor particles and a positively charged OPC layer 34.

What is claimed is:

1. A method of manufacturing a luminescent screen assembly on a face plate panel of a color cathode-ray tube, comprising:
applying an organic conductive layer on the face plate panel;
applying an organic photoconductive layer on the organic conductive layer;
charging the organic photoconductive layer to a desired voltage, thereby giving the organic photoconductive layer a surface charge of one polarity;
sequentially discharging selected portions of the charged organic photoconductive layer; and
affixing a color-emitting phosphor having a charge of the opposite polarity as that of the organic photoconductive layer onto the charged portions of the organic photoconductive layer after each discharging step.

2. The method of claim 1 wherein the negative voltage is within a range of about −200 volts to about −600 volts.

3. The method of claim 1 wherein the color emitting phosphors are positively charged within a range of about 2 μC/gram to about 10 μC/gram.

4. The method of claim 1 wherein the positive voltage is within a range of about +200 volts to about +600 volts.

5. The method of claim 1 wherein the color emitting phosphors are negatively charged within a range of about −2 μC/gram to about −10 μC/gram.

6. A method of manufacturing a luminescent screen assembly on a face plate panel of a color cathode-ray tube (CRT), comprising:
applying an organic conductive layer on the face plate panel;
applying an organic photoconductive layer on the organic conductive layer;
charging the organic photoconductive layer to a desired voltage, thereby giving the organic photoconductive layer a surface charge of one polarity;
sequentially discharging selected portions of the charged organic photoconductive layer; and
affixing a color-emitting phosphor onto the organic photoconductive layer after each discharging step, wherein
for at least one charging, discharging, and affixing sequence, the organic photoconductive layer has a surface charge of one polarity and the corresponding color-emitting phosphor has a charge of the opposite polarity; and
for at least one other charging, discharging, and affixing sequence, the organic photoconductive layer has a surface charge of one polarity and the corresponding color-emitting phosphor has a charge of the same polarity.
